(19) United States
(12) Patent Application Publication
(10) Pub. No.: US 2015/0298978 A1
(43) Pub. Date: Oct. 22, 2015

(54) GRAPHENE, AND APPARATUS FOR MANUFACTURING THE SAME

(71) Applicant: DEUK IL PARK, Hwaseong-si (KR)

(72) Inventor: DEUK IL PARK, Hwaseong-si (KR)

(21) Appl. No.: 14/692,709

(22) Filed: Apr. 21, 2015

(30) Foreign Application Priority Data
Apr. 22, 2014 (KR) 10-2014-0047922
Apr. 22, 2014 (KR) 10-2014-0047923

(51) Int. Cl. C01B 31/04

(52) U.S. Cl. CPC C01B 31/0469; C01B 31/0438

(57) ABSTRACT

The present invention relates to technique for manufacturing graphene, more particularly, to graphene and an apparatus for manufacturing graphene which is manufactured massively using physical characteristic of graphite itself and exfoliating or transferring mechanism of various adhesive structures. The present invention also relates to graphene and an apparatus for manufacturing graphene generated by being seceded from at least one of the structures, after being exfoliated or transferred from a type of graphite material to at least one of structure, or generated by being seceded from at least one structure among a plurality of structures, after being continuously exfoliated or transferred from a type of graphite material to the plurality of structures.

This application claims the benefits of Korean Patent Application No. 10-2014-0047922, filed on Apr. 22, 2014 and Korean Patent Application No. 10-2014-0047923, filed on Apr. 22, 2014, the contents of which are hereby incorporated by reference herein in their entirety.

### BACKGROUND OF THE INVENTION

1. Field of the Invention

The present invention relates to technique for manufacturing graphene, more particularly, to graphene and an apparatus for manufacturing graphene which is manufactured massively using physical characteristic of graphite itself and exfoliating or transfer mechanism of various adhesive structures.

2. Related Art Technology

It is known that graphene has better electrical conductivity, thermal conductivity, and mechanical strength than such metals as copper, aluminium, and optically transparent nature.

Graphene has a structure of stacking honeycomb layers. In order to maintain ideally the characteristic, it should be formed with single layer and have large area. Graphene has such good characteristics, so it is suitable for solar cells, semiconductors, nuclear fusion reactors, base material of secondary batteries, base material of clear electrodes for displays and cellphones, and it is expected that applications of graphene will be broadened.

In particular, since graphene has good electrical conductivity and transparency, it is an ideal material for transparent electrodes of display devices.

CDV (Chemical Vapor Deposition) is a general method for manufacturing large-area graphene, however, there has been difficulties in commercializing because it requires high cost despite of low productivity. Nevertheless, research for applying graphene to transparent electrodes is widely progressed, because graphene manufactured by CVD is suitable for transparent electrodes of displays and cellphones which require high conductivity and visible ray transparency.

Meanwhile, graphene having single layer and large area has not only good electrical conductivity but also good thermal conductivity. However, it has low thermal capacity because it is thin. Therefore, it is hard to use graphene as a heat radiator for radiating high heat.

Graphite having graphene structure is suitable for a heat radiator. Graphite has structure of stacking honeycomb layers, and it is abundant in nature. In these days, graphite is widely applied to heat radiators of electrical devices. However, there is much technical difficulty in getting same characteristic as graphene from natural graphite.

Graphite must be exfoliated to be thin and large-area, in order to have characteristic of thermal radiation similar to graphene. In particular, in order to use graphite as a heat radiator, a state of graphite powder should be as thin and large-area as possible, and by using the graphite powder, the heat radiator must be manufactured to have enough volume to maintain proper device temperature.

As a conventional method of manufacturing graphite powder, there has been a mechanical method to grind graphite finely, or there has been a chemical method to obtain expanded graphite structure by oxidizing graphite powder under high temperature condition. However, it is technically hard to obtain graphite powder which is thin and large-area similar to graphene by this mechanical grind or chemical method.

Since graphite powder for a heat radiator manufactured by mechanically grinding method depends on the particle size of the graphite, the shape of particle is generally irregular and is similar to stone fragment. Generally, the graphite powder manufactured by mechanical grinding is used in case that the particle size of the graphite powder is smaller than 40 μm. As such, the graphite powder mechanically grinded has advantage that high density is guaranteed when it is spread or molded, and the size of particle can be controlled according to its purpose, however, it is difficult to control the thickness of particle, that is, the thickness of a honeycomb layer which is stacked layer by layer. Also, the method has advantage that proportion of pore is low owing to high density. On the other hand, the method has disadvantage that electrical conductivity and thermal conductivity decrease by increased contact resistance between powder particles.

The chemical method of manufacturing graphite powder for a heat radiator using oxidation-reduction reaction has advantage in high productivity. However, it has some disadvantage such that it may cause environmental pollution because it uses noxious material like sulfuric acid, and it is difficult to produce high purity graphite because of poor manufacturing environment.

Graphite oxidized under high temperature condition by chemical method become powder form which is bulky and has very low density by expansion, and this powder form of graphite is used as a sheet for heat radiating of electronic devices. The expanded graphite powder of which particle size is less than 300 μm is mainly used for heat radiating purpose. The expanded graphite powder has microscopically similar to the shape of bellows, and macroscopically, it is cotton-shaped and light-weighted. However, as the volume of the graphite powder is expanded by oxidizing process under high temperature condition, many pores are generated by cracking gap between layers like bellows. Therefore, the particle size of those expanded graphite powder is bigger and thinner than that of the powder manufactured by grinding natural graphite, so its electronic conductivity and thermal conductivity is high, however, many pores existed between particles also cause to reduce thermal conductivity.

Meanwhile, in order to solve such problem as degrade of characteristic caused by many pores of expanded graphite powder, there has been improved method such as compressing the expanded graphite powder with high pressure, or mixing the expanded graphite powder with graphite powder of small size particles or with conductive metal powder, however, the effect of improvement has not been sufficient.

After all, according to the conventional art, in order to manufacture efficient heat radiators, graphite material has to be exfoliated as thinly and largely possible, and it should have electrical and thermal conductivity similar to graphene, also pores have to be minimized which degrade electrical and thermal conductivity.

Especially, according to the mechanical grinding method and chemical manufacturing method, it is technically very difficult to obtain graphite powder of which form is thin and large-area, and those are very limited methods to solve the problem caused by many pores existing between particles.

For now, normal thickness of graphite powder on a radiating sheet for radiating heat from cellphone is more than 25 μm, and normal thickness of graphite powder on a radiating sheet for LCD TV is more than 1 mm. In order to reduce thickness of the radiating sheet used for such electronic devices, and in order to improve radiating efficiency, thin and wide exfoliation of graphite powder and minimization of pores existing between graphite powder particles are needed at the same time. For this purpose, a technique to exfoliate graphite powder to be thin and large-area similar to graphene is needed.

### SUMMARY OF THE INVENTION

### Object of the Invention

An object of the present invention, which is invented considering the above problems, is to provide graphene and an apparatus for manufacturing graphene, solving the problems such as insufficient exfoliation of graphite powder and degradation of electrical and thermal conductivity caused by small particle size.

The other object of the present invention is to provide graphene and an apparatus for manufacturing graphene, solving the problems such as degradation of electric and thermal conductivity caused by pores existing between particles and environmental problem caused by using noxious material to human body.

Another object of the present invention is to provide graphene and an apparatus for manufacturing graphene improving characteristic of graphite material, in comparison with mechanical grinding method or chemical manufacturing method.

### Technical Solutions of the Invention

A technical feature of graphene according to the present invention which is invented in order to achieve above-mentioned objects is that graphene is generated by being seceded from at least one structure, after being exfoliated or transferred from a form of graphite material to the at least one structure.

The other technical feature of graphene according to the present invention which is invented in order to achieve above-mentioned objects is that graphene is generated by being seceded from a plurality of structures, after being continuously exfoliated or transferred from a form of graphite material to the plurality of structures.

A technical feature of the apparatus for manufacturing graphene according to the present invention which is invented in order to achieve above-mentioned objects is that the apparatus comprises at least one structure generating graphene particles on the surface of the at least one structure by exfoliating or transferring graphite material, and a seceding part for seceding the generated graphene particles from the surface of the at least one structure.

The other technical feature of the apparatus for manufacturing graphene according to the present invention which is invented to achieve above-mentioned objects is that the apparatus comprises a plurality of structures generating graphene particles on the surface of the plurality of the structures by continuously exfoliating or transferring graphite material, and a seceding part for seceding the generated graphene particles from the at least one surface among the plurality of structures.

### Effect of the Invention

According to the present invention, it has effects as below.

Firstly, graphene can be manufactured by carrying out exfoliation or transfer processes continuously and quickly from inputted graphite material, using the apparatus of the present invention having an adhesive layer on various structures such as a roller or a plate. According to this, more convenient manufacturing process is provided, and productivity can be remarkably improved as well.

Secondly, according to the present invention, since exfoliation and transfer are carried out continuously by an adhesive layer formed on the structure, it is advantageous that extremely thin graphene particles can be obtained from inputted graphite material, and thin and large-area graphene powder can be manufactured from the graphene particles.

The Thirdly, according to the present invention, since enough exfoliation is carried out from inputted graphite material and thin and large-area graphene particle can be manufactured, it is advantageous that graphene and conductor having high electrical and thermal conductivity can be manufactured.

Fourthly, since not only pores between particles (graphene particles) are not generated, but also noxious materials to human body are not used, different from mechanical grinding method or chemical manufacturing method, the present invention has advantage that it can optimally provide the superior characteristic of graphene without occurring environmental problems.

### BRIEF DESCRIPTION OF THE DRAWINGS

FIG. 1 is a diagram to illustrate process for manufacturing graphene according to the first embodiment of the present invention, which is one example of manufacturing graphene using at least one roller and graphite powder;

FIG. 2 is a diagram to illustrate process for manufacturing graphene according to the second embodiment of the present invention, which is the other example of manufacturing graphene using graphite powder and at least one roller;

FIG. 3 is a diagram to illustrate process for manufacturing graphene according to the third embodiment of the present invention, which is one example of manufacturing graphene using multiple rollers and graphite powder;

FIG. 4 is a diagram to illustrate process for manufacturing graphene according to the fourth embodiment of the present invention, which is one example of manufacturing graphene using at least one roller and graphite cylinder;

FIG. 5 is a diagram to illustrate process for manufacturing graphene according to the fifth embodiment of the present invention, which is one example of manufacturing graphene using at least one roller and graphite plate;

FIG. 6 is a diagram to illustrate process for manufacturing graphene according to the sixth embodiment of the present invention, which is one example of manufacturing graphene using at least one roller and plate structure;

FIG. 7 is a diagram to illustrate process for manufacturing graphene according to the seventh embodiment of the present invention, which is one example of manufacturing graphene using at least one plate structure;

FIG. 8 is a diagram to illustrate process for manufacturing graphene according to the eighth embodiment of the present invention, which is one example of manufacturing graphene using a plurality of plate structures,

FIG. 9 is a diagram to illustrate process for manufacturing graphene according to the ninth embodiment of the present invention, which is one example of manufacturing graphene using at least one roller and cylinder structure.

### DETAILED DESCRIPTION OF THE INVENTION

The method to achieve the objects of the present invention can be clearly understood by referring the attached drawings along with embodiments. However, the present invention is not limited to embodiments disclosed below, but it could be embodied as various formations. These embodiments are for completing disclose of the present invention, and are also provided for the purpose of complete explanation of scope of the present invention to those who are skilled in the art. The present invention is just defined by the scope of claims. All over the specification, a reference number is used to refer to an identical element.

Graphene and the apparatus for manufacturing graphene according to embodiments of the present invention are explained as below, along with referring to the drawings.

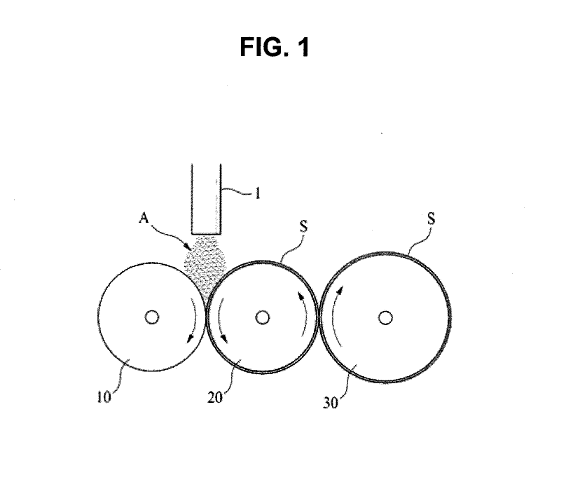

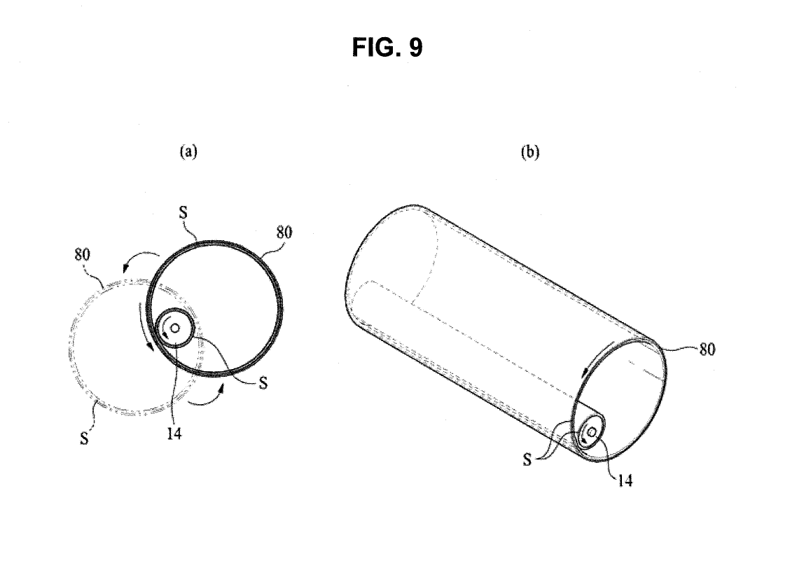

Graphene according to the present invention is manufactured by the apparatus for manufacturing graphene explained below, and thin and large-area graphene particles and graphene powder can be manufactured by the apparatus illustrated in FIG. 1˜FIG. 9. In particular, graphene can be manufactured by being exfoliated or transferred as thin and large-area as possible, taking advantage of little binding force between layers, which is an attribute of graphite itself. Also, the apparatus of the present invention can be used for manufacturing conductors such as electrical or thermal conductors by spreading or molding the manufactured graphene particles.

The apparatus according to the present invention, not only for manufacturing graphene itself, but also for manufacturing conductors from the manufactured graphene is for manufacturing graphene particles exfoliated or transferred on the surface of adhesive layer from graphite material by forming an adhesive layer on the surface (outer surface) of structure shaped like roller or plate, and repeatedly pressing graphite powder inputted into the structure.

The apparatus according to the present invention, for manufacturing graphene and conductors applies various shape of structures, and is not limited to such structures as roller, plate, or cylinder illustrated in FIG. 1˜FIG. 9 below. That is, various structures which are able to carry out exfoliation or transfer continuously and quickly from graphite material by forming adhesive layer on the surface (outer surface) of those various structures can be applied. FIG. 1 illustrates an antenna using ground radiation according to a first embodiment of the present invention.

More particularly, the apparatus for manufacturing graphene according to the present invention manufactures graphene by taking advantage of structural attribute of graphite itself. Graphite is structured by being stacked layers, wherein the layers comprises of plurality of honeycombs, and binding force between the honeycombs is strong, however, binding force between the layers is weak. Using this attribute, graphene is generated by applying a principle that if a structure is taken apart, after putting pressure on and contacting the surfaces of graphite layers with a structure on which surface has adhesion, then the layers of graphite can be easily exfoliated, and the exfoliated layers can be transferred to other adhesive structure.

Also, graphene according to the present invention, in order to improve productivity, can be manufactured by a graphene manufacturing apparatus carrying out exfoliation and transfer continuously and quickly by implementing plurality of structures continuously.

FIG. 1 is a diagram to illustrate process for manufacturing graphene according to the first embodiment of the present invention, which is one example of manufacturing graphene using at least one roller and graphite powder.

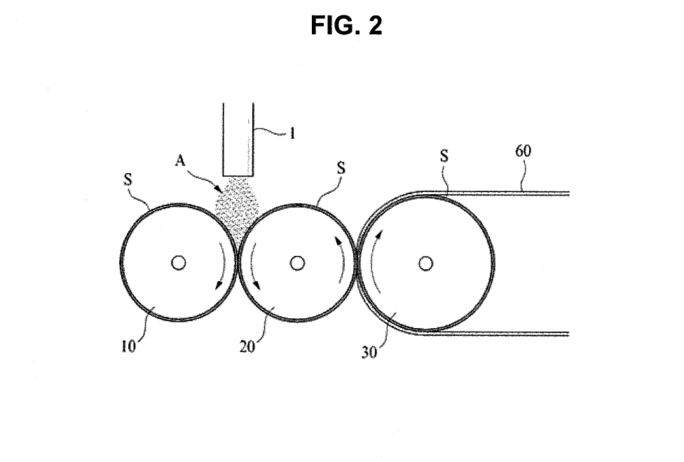

FIG. 2 is a diagram to illustrate process for manufacturing graphene according to the second embodiment of the present invention, which is the other example of manufacturing graphene using graphite powder and at least one roller.

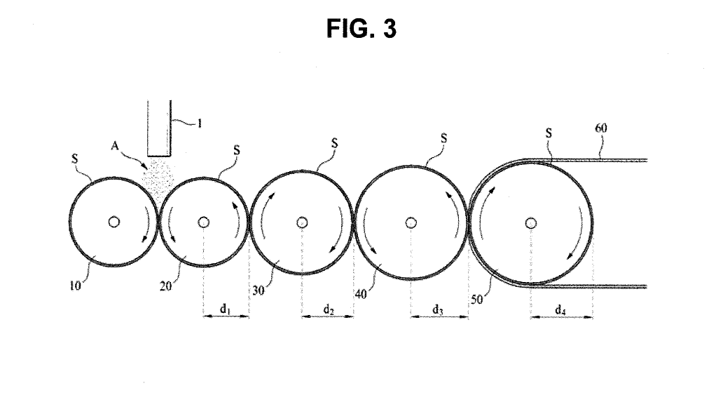

FIG. 3 is a diagram to illustrate process for manufacturing graphene according to the third embodiment of the present invention, which is one example of manufacturing graphene using multiple rollers and graphite powder.

Referring to FIG. 1˜FIG. 3, the apparatus for manufacturing graphene comprises at least one structure, an input structure for inputting graphite material, and a seceding structure for seceding graphene particle from surface of the structure.

The at least one structure illustrated in FIG. 1 and FIG. 2 comprises rollers 10, 20, 30, and the input structure comprises input part 1, the plurality of structures illustrated in FIG. 3 comprise a plurality of rollers 10, 20, 30, 40, 50, and the input structure comprises input part 1, such as FIG. 1 and FIG. 2.

The rollers 10, 20, 30, 40, 50 illustrated as a structures in FIG. 1˜FIG. 3 include the first roller 10, the second roller 20, the third roller 30, the fourth roller 40, the fifth roller 50.

The input part 1 is for inputting graphite material A, and the graphite material A may be inputted as powder type. Especially, the powder type graphite material may be inputted together with adhesive liquid or solid material through the input part 1.

An adhesive layer S may be formed on the surface of at least one roller among the rollers 10, 20, 30, 40, 50.

FIG. 1 illustrates an example that the second roller 20 has an adhesive layer among rollers 10, 20 performing contacted rolling with each other on the position where the graphite material is inputted, and the third roller 30 performing contacted rolling with the second roller 20 has an adhesive layer.

As illustrated in FIG. 2 or FIG. 3, all rollers 10˜50 may have an adhesive layer S, including rollers 10, 20 performing contacted rolling with each other on the position where the graphite material is inputted.

That is, in FIG. 1˜FIG. 3, the adhesive layer S may be formed on at least one surface of the rollers 10, 20, 30, 40, 50.

The adhesive layer S may be made of elastic rubber, and as an example, the elastic rubber includes silicon rubber which is a kind of rubber. The adhesive layer may be made of adhesive rubber having low hardness adhesion, or be formed by spreading adhesive liquid. Also, rollers 10, 20, 30, 40 may have adhesive layers of which adhesion are different with each other.

Meanwhile, the apparatus according to the present invention may further include a seceding part (not shown) corresponding to a seceding structure, and a graphene generator (not shown) generating transparent graphene from seceded graphene particles using the seceding part.

Especially, the graphene generator (not shown) may manufacture an electrical or thermal conductor by spreading or molding the generated graphene on a sheet or a film.

The seceding part discussed above may secede graphene particles from the structure using material under certain pressure and temperature condition.

In the apparatus illustrated in FIG. 1˜FIG. 3, graphite material inputted into between first roller 10 and the second roller 20 is pressed by rolling of the first roller 10 and the second roller 20. Caused by this, graphene particle is exfoliated from the graphite material. After that, the graphene particles adhered to the surface of the second roller 20 is transferred to the third roller according to the contacted rolling of the second roller 20 and the third roller 30.

In the example illustrated in FIG. 3, graphene particle can be formed thinly and of large-area by continuous exfoliation or transfer of graphite material from the second roller 10 to the fifth roller 50.

In the examples of FIG. 2 and FIG. 3, graphene material can be exfoliated on the surface of the first roller 10 as well, as an adhesive layer is formed on the surface of the first roller 10.

As such, the apparatus illustrated in FIG. 1˜FIG. 3 has at least two rollers having certain diameter.

According to contacted rolling of the first roller 10˜the fifth roller 50, graphene particles are exfoliated and transferred from powder type graphite material on an adhesive layer S formed on the surface.

In order to increase quantity of graphene particles transferred on the surface of the roller, to have rollers of which diameters are different with each other is preferred. Because of the bigger the size of diameter of the roller, the wider the surface area, the quantity of transferred graphene particles is increased. That is, as illustrated FIG. 1˜FIG. 3, it is preferred that the diameter of the third roller 30 is bigger than that of second roller 20. FIG. 3 is an example of increased diameters from the second roller 20 to the fifth roller 50.

For example, in case that 5 rollers are used for the apparatus of manufacturing graphene, 5 rollers of which diameters are different with each other in order of 100 mm, 130 mm, 160 mm, 190 mm, 210 mm.

Preferably, in the apparatus for manufacturing graphene, distance between the first roller 10 and the second roller 20 is adjusted, in order to apply different pressures according to the particle size of inputted powder type graphite material.

As an example of the present invention, powder type graphite material of which average sizes are 35 μm (400 mesh), 43 μm (325 mesh), 61 μm (250 mesh), 74 μm (200 mesh), 140 μm (100 mesh), 980 μm (18 mesh), 1300 μm (14 mesh), 1900 μm (10 mesh), 2460 μm (8 mesh), 2870 μm (7 mesh), 3350 μm (6 mesh) can be used.

In case of using graphite material of which particle size is relatively small such as 35 μm, 43 μm, 61 μm, 74 μm, 140 μm as powder type graphite material, inputted graphite material is pressed by contacted rolling of the first roller 10 and the second roller 20, and in case of using graphite material of which particle size is relatively big such 980 μm, 1300 μm, 1900 μm, 2460 μm, 2870 μm, 3350 μm, distance between the first roller 10 and the second roller 20 can be adjusted.

In the example of FIG. 3, in case of inputting graphite powder of which particle size is relatively small such as 35 μm˜140 μm, and as the size of particle become bigger, quantity of graphene particles exfoliated and transferred on the last fifth roller 50 can be increased, if the size of the particle is bigger than 61 μm. While, in case that the size of particle is 43 μm which is smaller than 61 μm, quantity of graphene particles exfoliated and transferred to the fifth roller 50 is considerably decreased in comparison with the case of particle size 61 μm, and in case of the particle size 35 μm which is smaller than 61 μm, quantity of graphene particle transferred to the fifth roller 50 can be significantly decreased.

As such, since efficiency of exfoliation and transfer is decreased by using graphite material of which particle size is very small, preferably, in the apparatus for manufacturing graphene according to present invention, powder type graphite material having proper particle size is inputted and used.

As an example, in case of power type graphite material having relatively big size such as 980 μm˜2870 μm, the graphite powder is exfoliated and transferred, eventually graphene particles can be effectively transferred to the last fifth roller 50. However, as the size of particle become bigger, quantity of graphite powder dropped between the first roller 10 and the second roller 20 by gravity is increased, particle size of the graphene transferred to the fifth roller 50 may become irregular. Meanwhile, in case of reducing input of graphite powder of which particle size is relatively small, quantity of graphite powder dropped between the first roller 10 and the second roller 20 by gravity is decreased, and the particle size of the graphene transferred to the fifth roller 50 is relatively regular.

In case that particle size is 3350 μm, graphite powder exfoliated from the first roller 10 and the second roller 20 can be effectively transferred to other rollers such as the third roller 30, the fourth roller 40, and the fifth roller 50. However, an adhesive layer S being spread or formed on the first roller 10 and second roller 20 may be damaged. Therefore, in the apparatus for manufacturing graphene according to present invention, in case of inputting graphite material of which particle size is big, preferably the distance between the first roller 10 and the second roller 20 is adjusted as relatively long, the adhesive layer S spread or formed on the first roller 10 and the second roller 20 is formed as thick, and the adhesive of which hardness is low is formed.

As another example, in case of inputting graphite material of which particle size is big between the first roller 10 and the second roller 20, the graphite material and adhesive liquid or adhesive solid material such as silicon may be inputted together.

In the apparatus for manufacturing graphene according to present invention, preferably graphite material of which particle size is smaller than 3350 μm is used, considering reliability.

As the examples illustrated in FIG. 1˜FIG. 3, in case of manufacturing graphene using rollers, taking into account the particle size of inputted graphite material and the desired graphene thickness, the number of rollers, the size (diameter) of roller, rolling velocity of roller, thickness and hardness of adhesive layer S spread or formed on the roller, distance between rollers, pressure pressed on inputted graphite material may be adjusted.

According to the embodiment of the present invention, graphite material of which particle size is between 61 μm and 3350 μm is used, and if possible, powder type graphite material of which particle size is regular is preferred.

Meanwhile, as illustrated in FIG. 1˜FIG. 3, plurality of rollers can be installed with adjacent and continuous manner to each other, that makes manufacturing convenience and productivity better by separating one structure (the first roller and the second roller) where graphite material is inputted from the other structure (the third roller and the fifth roller) where graphene particles are generated, also, the more rollers are employed, the more extremely exfoliated graphene particles can be generated.

In the apparatus for manufacturing graphene according to the present invention, as the seceding part (not shown) is for extracting graphene particles which are transferred to the adhesive layer S of the adhesive surface on the roller, the adhesive layer spread or formed on the roller is installed to be easily separated from the roller in order that secession of graphene particles can be easily performed by the seceding part (not shown).

The seceding part (not shown) and the graphene generator (not shown) can collect the transferred and adhered graphene particles on the adhesive layer S of the third roller 30 illustrated in FIG. 1 and FIG. 2 or of the fifth roller illustrated in FIG. 3. For example, graphene particles can be seceded by installing a brush or a water supplier to flow water.

For another example, graphene particles are spread on a sheet (or film) 60 by inserting a adhesive sheet (or film) 60 between the rollers and transferring graphene particles to the sheet (or film) 60, as illustrated in FIG. 2 and FIG. 3.

Graphene particles generated by repeated exfoliation and transfer using the apparatus for manufacturing graphene according to the present invention may have a shape of fish scale which is different from the shape of particles generated by mechanical grinding or chemical method, and the particles gradually get thinner as the transferring of particles are processed continuously and repeatedly. According to this, thin graphene particles too transparent to recognize with naked eye can be manufactured.

In the examples illustrated in FIG. 1˜FIG. 3, the number of rollers, the size (diameter) of roller, rolling velocity of roller, thickness and hardness of adhesive layer S spread or formed on the roller distance between rollers, pressure pressed on inputted graphite material may be adjusted, and massive manufacturing of thin and large-area graphene is also possible.

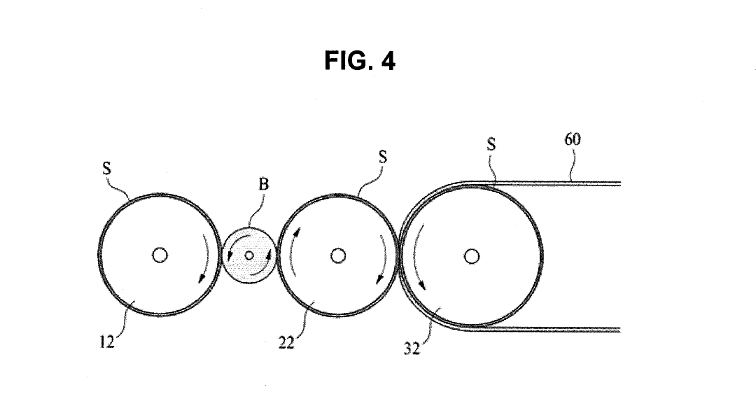

FIG. 4 is a diagram for explaining the process for manufacturing graphene, and this is an example of manufacturing graphene using at least one roller and graphite cylinder.

The example illustrated in FIG. 4 is an example of using a cylinder-shaped graphite material which plays a role of a roller, different from the method of inputting powder type graphite material in the example of FIG. 1˜FIG. 3.

A cylinder-shaped graphite material or a graphite cylinder is formed to be able to roll contacting with a structure. Herein, the structure can be made of rollers 12, 22, 32, excluding the input part 1.

The rollers 12, 22, 32 exampled as the structure include the sixth roller 12, the seventh roller 22, the eighth roller 32.

As the graphite cylinder B is located between the sixth roller 12 and the seventh roller 22, it rolls contacting with the sixth roller 12 and the seventh roller 22 as well.

At least one of the sixth roller˜the eighth roller 11, 22, 32 may have adhesive layer S on its surface, and the example of FIG. 4 illustrates that the adhesive layer S is formed on all rollers of the sixth roller, the seventh roller and the eighth roller.

Since explanation for the adhesive layer S is the same as that of FIG. 1˜FIG. 3, detailed explanation is omitted, also, since the seceding part (not shown) and the graphene generator (not shown) are applied with same manner, detailed explanation is omitted as well.

In the apparatus illustrated in FIG. 4, the sixth roller 12 and the seventh roller 22 make the graphite cylinder B roll, contacting with and putting certain pressure on the graphite cylinder B located therebetween, graphene particles are exfoliated from the graphite cylinder B to the sixth roller 12 and the seventh roller 22 by contacted rolling. In succession, the graphene particles adhered to the seventh roller 22 are transferred to the eighth roller 32 by contacted rolling.

In the example of FIG. 4, as an adhesive layer S is formed on the surface of the sixth roller 12 and the seventh roller 22, graphene particles can be simultaneously exfoliated on the surface of the sixth roller 12 and the seventh roller 22. Therefore, an additional transfer structure according to rolling of the seventh roller 22 and the eighth roller 32 can be provided at the various location with the graphite cylinder B as a center.

Meanwhile, the diameter of the eighth roller 32 may be bigger than that of the seventh roller 22 in order to increase quantity of transferred graphene particles.

Also, in the example of FIG. 4, graphene particles can be directly transferred on an adhesive sheet (or film) 60 by inserting the sheet (or film) 60 between the seventh roller 22 and the eighth roller 32.

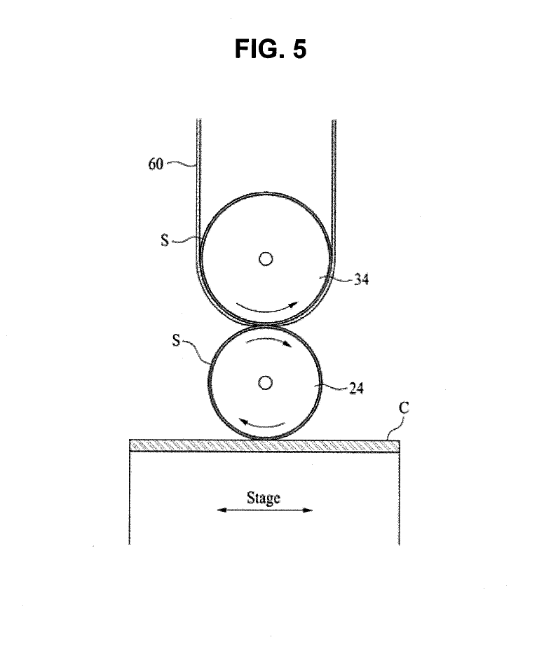

FIG. 5 is a diagram for explaining process for manufacturing graphene according to the fifth embodiment of the present invention, which is an example of manufacturing graphene using at least one roller and graphite plate C.

The example illustrated in FIG. 5 is an example of manufacturing graphene using a graphite plate C, different from the method of inputting graphite material of powder type as illustrated in FIG. 1˜FIG. 3, and the method of installing a graphite cylinder between rollers as illustrated in FIG. 4.

A plate type graphite material, that is a graphite plate C, may be formed to contact with a structure and to perform linear reciprocating motion, so as to make the structure roll. Wherein, the structure may comprise rollers 24, 34, excluding the input part 1.

The rollers 24, 33 exampled as the structure may include the ninth roller 24 and the tenth roller 34.

The graphite plate C is installed on upper surface of the stage, and performs reciprocating motion linearly contacting with the ninth roller 24. The ninth roller 24 rolls according to the linear reciprocating motion of the graphite plate C. The tenth roller 34 rolls contacting with the ninth roller 24.

The adhesive layer S on which surface has adhesion can be formed on the surface of the ninth or tenth roller 24, 34, and FIG. 5 illustrates an example that the adhesive layer S is formed or spread on the ninth or the tenth roller 24, 34.

Omitted detail explanation of the adhesive layer S, because that is already explained in FIG. 1˜FIG. 3. Also, omitted detail explanation of the seceding part (not shown) and the graphene generator (not shown), because they are applied with same manner.

In the apparatus illustrated in FIG. 5, the graphite C make the ninth roller 24 roll contacting with and putting pressure on the ninth roller 24, and graphene particles are exfoliated from the graphite plate C to the ninth roller 24. After that, the graphene particles adhered on the surface of the ninth roller 24 are transferred to the tenth roller 34, according to the contacted rolling of the ninth roller 24 and the tenth roller 34.

Meanwhile, the diameter of the tenth roller 34 may be bigger than that of the ninth roller 24, in order to gain transferred graphene particles more.

In the example of FIG. 5 as well, graphene particles can be transferred directly to the sheet (or film) 60 by inserting the adhesive sheet (or film) 60 between the ninth roller 24 and the tenth roller 34.

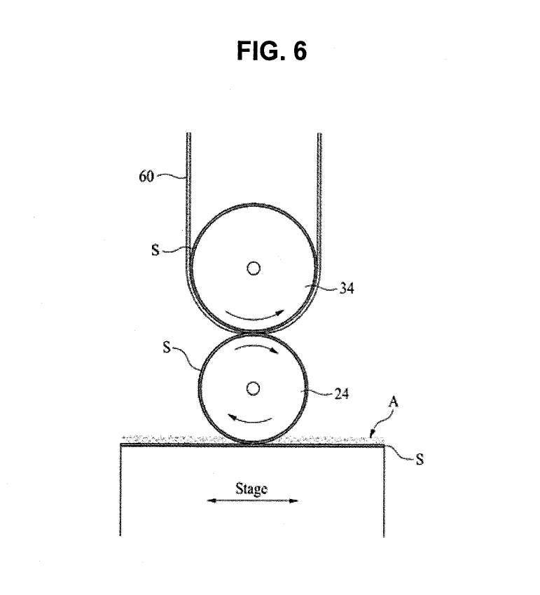

FIG. 6 is a diagram to explain a process for manufacturing graphene according to the sixth embodiment, which is an example of manufacturing graphene using at least one roller and plate structure.

The example of FIG. 6 is similar to that of FIG. 5, however, this is an example that powder type graphite material is inputted into the upper surface of the stage, instead of the graphite plate C.

With powder type graphite material, which is graphite powder A, being inputted into the upper surface of the stage, the stage performs linear reciprocating motion contacting with the ninth roller 24. According to this, the ninth roller 24 rolls by the linear reciprocation motion of the stage. The tenth roller 34 roller contacting with the ninth roller 24.

Meanwhile, on the upper surface of the stage where graphite powder A is inputted, an adhesive layer S may be formed, and an adhesive layer S may be formed on the ninth or tenth roller as well.

In the example of FIG. 6, the same exfoliation and transfer are performed as the example of FIG. 5.

Though it is explained that graphene particles are exfoliated and transferred to the rollers 24, 34 by performing liner reciprocation motion in the examples of FIG. 5 and FIG. 6, it is possible that the graphene particles are exfoliated and transferred from the upper surface of the stage by simultaneous rolling of the ninth roller 24 and the tenth roller 34 with the stage fixed.

The distance between the stage and the ninth roller 24 may be adjusted for the purpose of efficient exfoliation and transfer.

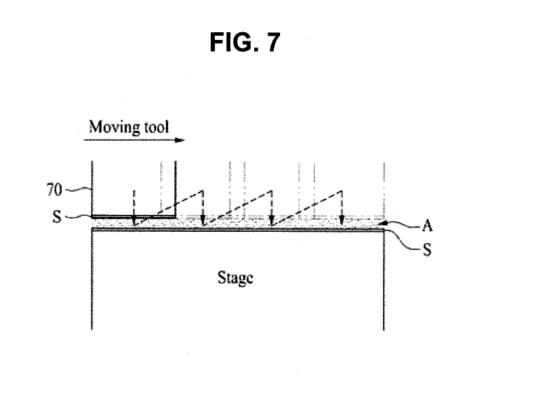

FIG. 7 is a diagram to explain a manufacturing process of graphene according to the fifth embodiment of the present invention, and this is an example of manufacturing graphene using at least one plate structure.

In the example of FIG. 7, powder type graphite material is inputted on the upper surface of the stage, similar to the example of FIG. 6. However, in this example, instead of exfoliation and transfer by rolling of rollers, the exfoliation is performed by the moving tool 70 which performs up-and-down motions and interval moving on and above the upper surface of the stage, after inputting powder type graphite material on the upper surface of the fixed stage.

The adhesive layer S may be formed on the upper surface of the stage, and graphite powder A is inputted on the adhesive layer S.

The moving tool 70 has an adhesive layer S on the lower surface facing the stage.

The moving tool 70 performs up-and-down motions and interval moving on and above the upper surface of the stage on which graphite powder A is inputted, by this, the moving tool 70 repeatedly put pressure on the graphite powder A which is inputted on the upper surface of the stage. With this process, graphene particles are exfoliated on the adhesive layer S which is spread or formed on the moving tool 70.

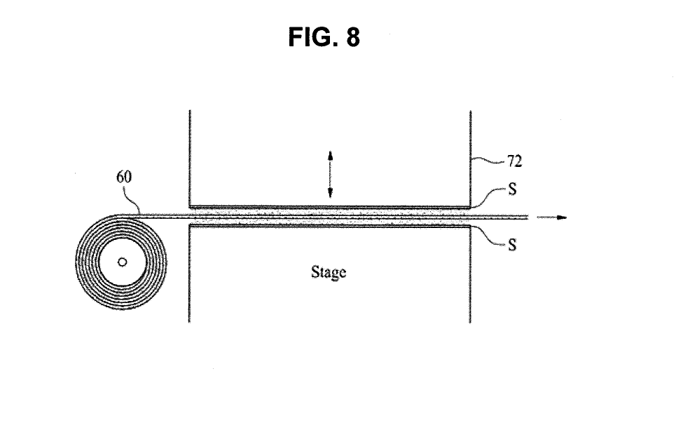

FIG. 8 is a diagram to explain a manufacturing process of graphene, according to the eighth embodiment of the present invention, and this is an example of manufacturing graphene using plurality of plate structure.

In the example of FIG. 8, powder type graphite material is inputted on the upper surface of the stage, similar to the examples of FIG. 6 and FIG. 7. However, in this example, instead of exfoliation and transfer by rolling of rollers, the exfoliation is performed by the moving tool 70 which is installed facing the stage and performs up-and-down motions, after inputting powder type graphite material on the upper surface of the fixed stage.

In particular, according to the example of FIG. 8, graphene particles are directly exfoliated and transferred on the sheet (or film) 60 by inserting the adhesive sheet (or film) 60 between the stage and the moving tool 72, and moving it forward. Wherein, an adhesive layer S may be formed on the upper surface of the stage, and the moving tool 72 may have an adhesive layer S on the lower surface facing the stage.

The moving tool 72 performs up-and-down motions on and above the upper surface of the stage where graphite powder A is inputted, by this, puts pressure on the graphite powder which inputted on the surface of the stage. Accordingly, graphene particles are exfoliated from graphite powder A to the adhesive layer S which is spread or formed on the moving tool 72.

FIG. 9 is a diagram to explain a manufacturing process of graphene, this is an example of manufacturing graphene using at least one roller and cylinder structure.

In the example of FIG. 9, powder type graphite material is inputted to the inside of the cylinder structure, and exfoliation is performed when the cylinder structure 80 rolls along the surface of the roller 14 which is installed inside the cylinder structure 80.

In particular, according to the example of FIG. 9, an adhesive layer S may be formed on the inside surface of the cylinder structure 80, and the roller 14 may have an adhesive layer S on its surface.

When the cylinder structure 80 rolls along the surface of inside roller and puts pressure on inputted graphite powder A, graphene particles are exfoliated from the graphite powder A on the adhesive layers spread or formed on the inside surface of the cylinder structure 80 and the surface of the roller 14.

It is preferable that the particle size of the graphite material is uniform in case of using powder type graphite material among the examples of FIG. 1˜FIG. 9.

Also, the layer S which is formed in the examples of FIG. 1˜FIG. 9 may be made of adhesive rubber having low hardness adhesion, or be formed by spreading adhesive liquid.

In the examples of FIG. 1˜FIG. 9, the adhesive layers may have the same thickness, or in case that powder type graphite material is inputted, different thicknesses can be applied to the adhesive layer S according to particle size of graphite material.

In case that the adhesive layer S is made of silicon rubber and graphite powder of which particle size is big is used, a silicon rubber of which hardness is 30 (Shore A) may be used, in order not to be damaged by edge of graphite powder and to overcome different pressures on the graphite powder caused by the size of particles, and to overcome different contact areas with roller surface. That is, in the apparatus for manufacturing graphene of this invention, thickness and hardness of the adhesive layer can be selected according to the size of graphite particle to be exfoliated.

Also, it is preferable that the distance at the location where the structure contacts is adjusted, wherein the structure includes a roller, a plate, and a cylinder, under consideration of the particle size of inputted graphite powder, and the forms of graphite material such as graphite cylinder or graphite plate being installed.

As an additional example of the present invention, the apparatus for manufacturing graphene according to the invention may have a container having an adhesive layer S on the inside surface and a sphere having an adhesive layer on its surface, and using these, can perform exfoliate or transfer graphene particles from graphite material. That is, graphene particles can be exfoliated or transferred from graphite material by performing that the sphere having the adhesive layer S moves in various direction inside the container where graphite powder is inputted. Wherein, it is preferable that the container rolls in order to allow the sphere to move.

As explained above, graphene according to the present invention can be manufactured, after being exfoliated or transferred from various forms of graphite material such as powder type, cylinder type like graphite cylinder, or plate type like graphite plate to at least one structure (roller, plate, or cylinder) on which an adhesive layer is spread or formed, by being seceded from the at least one structure.

A structure for generating graphene, as explained in the above embodiments, can be made by using a plurality of rollers, or at least one of roller and a plate, according to this, after being exfoliated to one structure and transferred to the other structure, graphene can be generated by being seceded.

In particular, graphene can be manufactured, after being exfoliated or transferred continuously to a plurality of structures, by being seceded from the plurality of structures, because graphene is manufactured by using plurality of structures.

Though the embodiments of the present invention are explained as above referring to the attached drawings, the present invention is not limited to the above-explained embodiments, but could be embodied with various formations. Also, it can be understood that those skilled in the art can carry out the present invention with detailed formation, without altering the technical matter or essential feature of the present invention. Therefore, the embodiments disclosed above must be understood as examples and not be limited to the embodiments themselves.

1. A graphene generated by being seceded from at least one structure, after being exfoliated or transferred from a form of graphite material to the at least one of structure.

2. The graphene of claim 1, wherein an adhesive layer is spread or formed on the at least one structure, after the graphite material is exfoliated or transferred to the adhesive layer spread or formed on the at least one structure, the graphene is generated by being seceded from the adhesive layer.

3. The graphene of claim 1, wherein the at least one structure includes a first structure and a second structure, wherein the graphite material is exfoliated to an adhesive layer spread or formed on the first structure, after being transferred from the adhesive layer spread or formed on the first to an adhesive layer spread or formed on the second structure, the graphene is generated by being seceded from the adhesive layer spread or formed on the second structure.

4. The graphene of claim 1, wherein the graphene generated by being seceded from at least one structure among a plurality of structures, after continuously being exfoliated or transferred from the graphite material to the plurality of structures.

5. The graphene of claim 4, wherein respective adhesive layers are spread or formed on the plurality of structures, after the graphite material is exfoliated or transferred to the adhesive layers spread or formed on the plurality of structures, the graphene is generated by being seceded from the adhesive layer spread or formed on at least one of the structure among the plurality of structures.

6. The graphene of claim 1, wherein the graphene is generated by using the graphite material as a form of a powder type, plate type or cylinder type.

7. The graphene of claim 1, wherein the graphene is generated as a powder type particles by being seceded from the at least one of structure.

8. An apparatus for manufacturing graphene, comprising:
at least one structure for generating graphene particles on a surface of the at least one structure by exfoliating or transferred graphite material; and
a seceding part for seceding the graphene particles from the surface of the at least one structure.

9. The apparatus of claim 8, wherein an adhesive layer is spread or formed on the surface of the at least one structure.

10. The apparatus of claim 9, wherein the graphene particles are generated from the graphite material to the adhesive layer spread or formed on the at least one structure by being exfoliated or transferred, and the seceding part secedes the graphene particles exfoliated or transferred, from the adhesive layer.

11. The apparatus of claim 8, wherein the at least one structure includes a first structure and a second structure having an adhesive layer on each surface of the first and the second structure, wherein the graphene particles are generated by being exfoliated from the graphite material to the adhesive layer of the first structure, and the graphene particles are generated more by being transferred from the adhesive layer of the first structure to the adhesive layer of the second structure.

12. The apparatus of claim 8, wherein the at least one structure generates the graphene particles on the surfaces of the structures by continuously exfoliating or transferring the graphite material.

13. The apparatus of claim 8, further comprises an input part for inputting powder type graphite material, wherein the graphite material is inputted together with adhesive liquid or solid through the input part.

14. The apparatus of claim 8, wherein the structure includes rollers of which diameters are different with each other, and the rollers perform contacted rolling, wherein an adhesive layer is spread or formed on the each surface of the rollers.

15. The apparatus of claim 14, wherein the structure further comprises a plate performing linear reciprocating motion contacting the roller.

16. The apparatus of claim 9, wherein the adhesive layer is made of elastic rubber including silicon rubber.

17. The apparatus of claim 8, further comprises a graphene generator for generating transparent graphene using the graphene particles seceded by the seceding part.

18. The apparatus of claim 17, wherein an electronic conductor or a thermal conductor is manufactured by spreading or molding the graphene generated by the graphene generator on a sheet or a film.

19. The apparatus of claim 8, wherein the graphite material is cylinder type, and the cylinder type graphite material performs contacted rolling.

20. The apparatus of claim 19, wherein the structure includes rollers performs rolling with different diameters with each other, wherein the rollers performs contacted rolling with the cylinder type graphite material located between the rollers.
